(19) United States
(12) Patent Application Publication
(10) Pub. No.: US 2022/0101144 A1
(43) Pub. Date: Mar. 31, 2022

(54) TRAINING A LATENT-VARIABLE GENERATIVE MODEL WITH A NOISE CONTRASTIVE PRIOR

(71) Applicant: NVIDIA CORPORATION, Santa Clara, CA (US)

(72) Inventors: Arash VAHDAT, Mountain View, CA (US); Jyoti ANEJA, Urbana, IL (US)

(21) Appl. No.: 17/211,681

(22) Filed: Mar. 24, 2021

Related U.S. Application Data
(60) Provisional application No. 63/083,635, filed on Sep. 25, 2020.

(51) Int. Cl. G06N 3/08; G06N 3/04

(52) U.S. Cl. CPC G06N 3/088; G06N 3/0454

(57) ABSTRACT

One embodiment of the present invention sets forth a technique for creating a generative model. The technique includes performing one or more operations based on a plurality of training images to generate an encoder network and a prior network, wherein the encoder network converts each image in the training images into a set of visual attributes, and the prior network learns a distribution of the visual attributes across the training images. The technique also includes training one or more classifiers to distinguish between values for the visual attributes generated by the encoder network and values for the visual attributes selected from the distribution learned by the prior network. The technique further includes combining the prior network and the classifier(s) to produce a trained prior component that, in operation, produces one or more values for the visual attributes to generate a new image that is not in the training images.

### CROSS-REFERENCE TO RELATED APPLICATIONS

This application claims benefit of United States Provisional Patent application titled “VARIATIONAL AUTOENCODERS WITH NOISE CONTRASTIVE PRIORS,” filed Sep. 25, 2020 and having Ser. No. 63/083,635. The subject matter of this related application is hereby incorporated herein by reference.

### BACKGROUND

### Field of the Various Embodiments

Embodiments of the present disclosure relate generally to machine learning and computer science, and more specifically, to training a latent-variable generative model with a noise contrastive prior.

### Description of the Related Art

In machine learning, generative models typically include deep neural networks and/or other types of machine learning models that are trained to generate new instances of data. For example, a generative model could be trained on a training dataset that includes a large number of images of cats. During training, the generative model “learns” the visual attributes of the various cats depicted in the images. These learned visual attributes could then be used by the generative model to produce new images of cats that are not found in the training dataset.

A variational autoencoder (VAE) is a type of generative model. A VAE typically includes an encoder network that is trained to convert data points in the training dataset into values of “latent variables,” where each latent variable represents an attribute of the data points in the training dataset. The VAE also includes a prior network that is trained to learn a distribution of the latent variables associated with the training dataset, where the distribution of latent variables represents variations and occurrences of the different attributes in the training dataset. The VAE further includes a decoder network that is trained to convert the latent variable values generated by the encoder network back into data points that are substantially identical to data points in the training dataset. After training has completed, new data that is similar to data in the original training dataset can be generated using the trained VAE, by sampling latent variable values from the distribution learned by the prior network during training and converting those sampled values, via the decoder network, into new data points. Each new data point generated in this manner can include attributes that are similar (but not identical) to one or more attributes of the data points in the training dataset.

For example, a VAE could be trained on a training dataset that includes images of cats, where each image includes tens of thousands to millions of pixels. The trained VAE would include an encoder network that converts each image into hundreds or thousands of numeric latent variable values. Each latent variable would represent a corresponding visual attribute found in one or more of the images used to train the VAE (e.g., appearances of the cats' faces, fur, bodies, expressions, poses, etc. in the images). Variations and occurrences in the visual attributes across all images in the training dataset would be captured by the prior network as a corresponding distribution of latent variables (e.g., as means, standard deviations, and/or other summary statistics associated with the numeric latent variable values). After training has completed, additional images of cats that are not included in the training dataset could be generated using the trained VAE by sampling latent variable values that fall within the distribution of latent variables learned by the prior network and converting those sampled latent variable values, via the decoder network, into new pixel values within the additional images of cats.

One drawback of using VAEs to generate new data is known as the “prior hole problem,” where, in the distribution of latent variables learned by a prior network based on a given training dataset, high probabilities are assigned to regions of latent variable values that do not correspond to any actual data in the training dataset. These regions of erroneously high probabilities typically result from limitations in the complexity or “expressiveness” of the distribution of latent variable values that the decoder in a VAE is capable of learning. Further, because these regions do not reflect attributes of any actual data points in the training dataset, when the decoder network in a VAE converts samples from these regions into new data points, those new data points usually do not resemble the data in the training dataset.

Continuing with the above example, the training dataset that includes images of cats could be converted by the encoder in the VAE, during training, into latent variable values that occupy a first set of regions. In turn, the distribution of latent variables learned by the prior network from the training dataset could include high probabilities for this first region, reflecting the fact that latent variable values within the first set of regions correspond to actual training data. However, the distribution learned by the prior network could also include high probabilities for a second set of regions that do not include any latent variable values generated by the encoder from the training dataset. In such a case, the high probabilities for this second set of regions are errant and mistakenly suggest that the second set of regions includes latent variable values that correspond to attributes of actual training data. As noted above, in these types of situations, the distribution learned by the prior network does not match the actual distribution of latent variables produced by the encoder network from the training dataset because the distribution learned by the prior network is simpler than or not as “expressive” as the actual distribution produced by the encoder network. Accordingly, if latent variable values falling within the second set of regions in the distribution of latent variables learned by the prior network were sampled and converted by the decoder network in the VAE into new pixel values, the resulting images would fail to resemble cats.

One approach to resolving the mismatch between the distribution of latent variables learned by the prior network and the actual distribution of latent variables generated by the encoder network from a training dataset is to use an energy-based model train with an iterative Markov Chain Monte Carlo (MCMC) sampling technique to train a machine learning model to learn a more complex, or “expressive,” distribution of latent variables to represent the training dataset. However, each MCMC sampling step depends on the result of the previous sampling step, which prevents MCMC sampling from being performed in parallel. Performing the different MCMC steps serially is both computationally inefficient and time-consuming.

As the foregoing illustrates, what is needed in the art are more effective techniques for generating new data using variational autoencoders.

### SUMMARY

One embodiment of the present invention sets forth a technique for creating a generative model. The technique includes performing one or more operations based on a training dataset to generate a trained encoder network and a trained prior network, wherein the trained encoder network converts a plurality of data points included in the training dataset into a set of latent variables, and the trained prior network learns a distribution of the set of latent variables across the training dataset. The technique also includes performing one or more operations to train one or more classifiers to distinguish between values for the set of latent variables generated via the trained encoder network and values sampled from the distribution learned by the trained prior network. The technique further includes creating a trained prior component based on the trained prior network and one or more classifiers, wherein the trained prior component applies a reweighting factor to one or more first values sampled from the distribution learned by the trained prior network to generate one or more second values for the set of latent variables, wherein, in operation, the trained prior component produces the one or more second values in order to generate a new data point that is not included in the training dataset.

At least one technical advantage of the disclosed techniques relative to the prior art is that the disclosed techniques produce generative output that looks more realistic and similar to the data in a training dataset compared to what is typically produced using conventional variational autoencoders. Another technical advantage is that, with the disclosed techniques, a complex distribution of latent variables produced by an encoder from a training dataset can be approximated by a machine learning model that is trained and executed in a more computationally efficient manner relative to prior art techniques. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computing device configured to implement one or more aspects of the various embodiments.

FIG. 2 is a more detailed illustration of the training engine and execution engine of FIG. 1, according to various embodiments.

FIG. 3A is an exemplar architecture for the encoder included in the hierarchical version of the VAE of FIG. 2, according to various embodiments.

FIG. 3B is an exemplar architecture for a generative model included in the hierarchical version of the VAE of FIG. 2, according to various embodiments.

FIG. 4A is an exemplar residual cell that is included in the encoder included in the hierarchical version of the VAE of FIG. 2, according to various embodiments.

FIG. 4B is an exemplar residual cell in a generative model included in the hierarchical version of the VAE of FIG. 2, according to various embodiments.

FIG. 5A is an exemplar residual block included in a classifier that can be used with the hierarchical version of the VAE of FIG. 2, according to various embodiments.

FIG. 5B is an exemplar residual block included in a classifier that can be used with the hierarchical version of the VAE of FIG. 2, according to other various embodiments.

FIG. 5C is an exemplar architecture for a classifier that can be used with the hierarchical version of the VAE of FIG. 2, according to other various embodiments.

FIG. 6 is a flow diagram of method steps for training a generative model, according to various embodiments.

FIG. 7 is a flow diagram of method steps for producing generative output, according to various embodiments.

FIG. 8 illustrates a game streaming system configured to implement one or more aspects of the various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

General Overview

A variational autoencoder (VAE) is a type of machine learning model that is trained to generate new instances of data after “learning” the attributes of data found within a training dataset. For example, a VAE could be trained on a dataset that includes a large number of images of cats. During training of the VAE, the VAE learns patterns in the faces, fur, bodies, expressions, poses, and/or other visual attributes of the cats in the images. These learned patterns allow the VAE to produce new images of cats that are not found in the training dataset.

A VAE includes a number of neural networks. These neural networks can include an encoder network that is trained to convert data points in the training dataset into values of “latent variables,” where each latent variable represents an attribute of the data points in the training dataset. These neural networks can also include a prior network that is trained to learn a distribution of the latent variables associated with the training dataset, where the distribution of latent variables represents variations and occurrences of the different attributes in the training dataset. These neural networks can additionally include a decoder network that is trained to convert the latent variable values generated by the encoder network back into data points that are substantially identical to data points in the training dataset. After training has completed, new data that is similar to data in the original training dataset can be generated using the trained VAE, by sampling latent variable values from the distribution learned by the prior network during training and converting those sampled values, via the decoder network, into new data points. Each new data point generated in this manner can include attributes that are similar (but not identical) to one or more attributes of the data points in the training dataset.

For example, a VAE could be trained on a training dataset that includes images of cats, where each image includes tens of thousands to millions of pixels. The trained VAE would include an encoder network that converts each image into hundreds or thousands of numeric latent variable values. Each latent variable would represent a corresponding visual attribute found in one or more of the images used to train the VAE (e.g., appearances of the cats' faces, fur, bodies, expressions, poses, etc. in the images). Variations and occurrences in the visual attributes across all images in the training dataset would be captured by the prior network as a corresponding distribution of latent variables (e.g., as means, standard deviations, and/or other summary statistics associated with the numeric latent variable values). After training has completed, additional images of cats that are not included in the training dataset could be generated using the trained VAE by sampling latent variable values that fall within the distribution of latent variables learned by the prior network and converting those sampled latent variable values, via the decoder network, into new pixel values within the additional images of cats.

VAEs can be used in various real-world applications. First, a VAE can be used to produce images, text, music, and/or other content that can be used in advertisements, publications, games, videos, and/or other types of media. Second, VAEs can be used in computer graphics applications. For example, a VAE could be used to render two-dimensional (2D) or three-dimensional (3D) characters, objects, and/or scenes instead of requiring users to explicitly draw or create the 2D or 3D content. Third, VAEs can be used to generate or augment data. For example, the appearance of a person in an image (e.g., facial expression, gender, facial features, hair, skin, clothing, accessories, etc.) could be altered by adjusting latent variable values outputted by the encoder network in a VAE from the image and using the decoder network from the same VAE to convert the adjusted values into a new image. In another example, the prior and decoder networks in a trained VAE could be used to generate new images that are included in training data for another machine learning model. Fourth, VAEs can be used analyze or aggregate the attributes of a given training dataset. For example, visual attributes of faces, animals, and/or objects learned by a VAE from a set of images could be analyzed to better understand the visual attributes and/or improve the performance of machine learning models that distinguish between different types of objects in images.

To assist a VAE in generating new data that accurately captures attributes found within a training dataset, the VAE is first trained on the training dataset. After training of the VAE is complete, a separate machine learning model called a “classifier” is trained to distinguish between values sampled from the distribution of latent variables learned by the prior network from the training dataset and the actual distribution of latent variables generated by the encoder network from the training dataset. For example, the VAE could first be trained to learn a distribution of latent variables representing visual attributes of human faces in images included in the training dataset. The classifier could then be trained to determine whether a set of latent variable values is produced by the encoder network in the VAE from an image in the training dataset or sampled from the distribution of latent variables learned by the prior network.

The trained VAE and classifier can then be used together to produce generative output that resembles the data in the training dataset. First, a set of latent variable values is sampled from the distribution of latent variables learned by the prior network, and the sampled latent variable values are inputted into the classifier to generate a “reweighting factor” that captures a difference between the sampled latent variable values and actual latent variable values generated by the encoder network from the data in the training dataset. Next, the reweighting factor is combined with the sampled latent variable values to shift the sampled latent variable values toward latent variable values generated by the encoder network from actual data in the training dataset. The shifted latent variable values are then inputted into the decoder network to produce new “generative output” that is not found in the training dataset.

For example, the prior network could store statistics related to latent variable values representing gender, facial expression, facial features, hair colors and styles, skin tones, clothing, accessories, and/or other attributes of human faces in images included in a training dataset. A set of latent variable values could be sampled using the statistics stored in the prior network, and the classifier could be applied to the sampled latent variable values to generate one or more values between 0 and 1 representing probabilities that the sampled latent variable values are produced by the encoder network from the training dataset and/or sampled using the prior network. The output of the classifier could then be converted into the reweighting factor, and the reweighting factor could be used to shift the sampled latent variable values away from regions that do not represent attributes of actual images in the training dataset. The decoder network could then be applied to the shifted latent variable values to generate a new image of a face with recognizable and/or realistic facial characteristics.

### System Overview

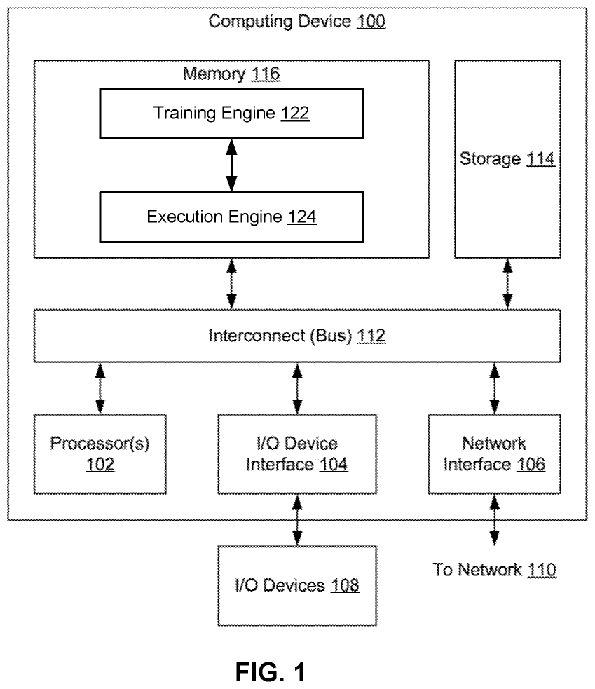

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a training engine 122 and execution engine 124 that reside in a memory 116. It is noted that the computing device described herein is illustrative and that any other technically feasible configurations fall within the scope of the present disclosure. For example, multiple instances of training engine 122 and execution engine 124 could execute on a set of nodes in a distributed and/or cloud computing system to implement the functionality of computing device 100.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

In one embodiment, I/O devices 108 include devices capable of receiving input, such as a keyboard, a mouse, a touchpad, and/or a microphone, as well as devices capable of providing output, such as a display device and/or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

In one embodiment, network 110 is any technically feasible type of communications network that allows data to be exchanged between computing device 100 and external entities or devices, such as a web server or another networked computing device. For example, network 110 could include a wide area network (WAN), a local area network (LAN), a wireless (WiFi) network, and/or the Internet, among others.

In one embodiment, storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Training engine 122 and execution engine 124 may be stored in storage 114 and loaded into memory 116 when executed.

In one embodiment, memory 116 includes a random access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 and execution engine 124.

Training engine 122 includes functionality to train a variational autoencoder (VAE) on a training dataset, and execution engine 124 includes functionality to execute one or more portions of the VAE to generate additional data that is not found in the training dataset. For example, training engine 122 could train encoder, prior, and/or decoder networks in the VAE on a set of training images, and execution engine 124 may execute a generative model that includes the trained prior and decoder networks to produce additional images that are not found in the training images.

In some embodiments, training engine 122 and execution engine 124 use a number of techniques to mitigate mismatches between the distribution of latent variables learned by the prior network from the training dataset and the actual distribution of latent variables outputted by the encoder network from the training dataset. More specifically, training engine 122 and execution engine 124 learn to identify and avoid regions in the latent variable space of the VAE that do not encode actual attributes of data in the training dataset. As described in further detail below, this improves the generative performance of the VAE by increasing the likelihood that generative output produced by the VAE captures attributes of data in the training dataset.

### Variational Autoencoder with a Noise Contrastive Prior

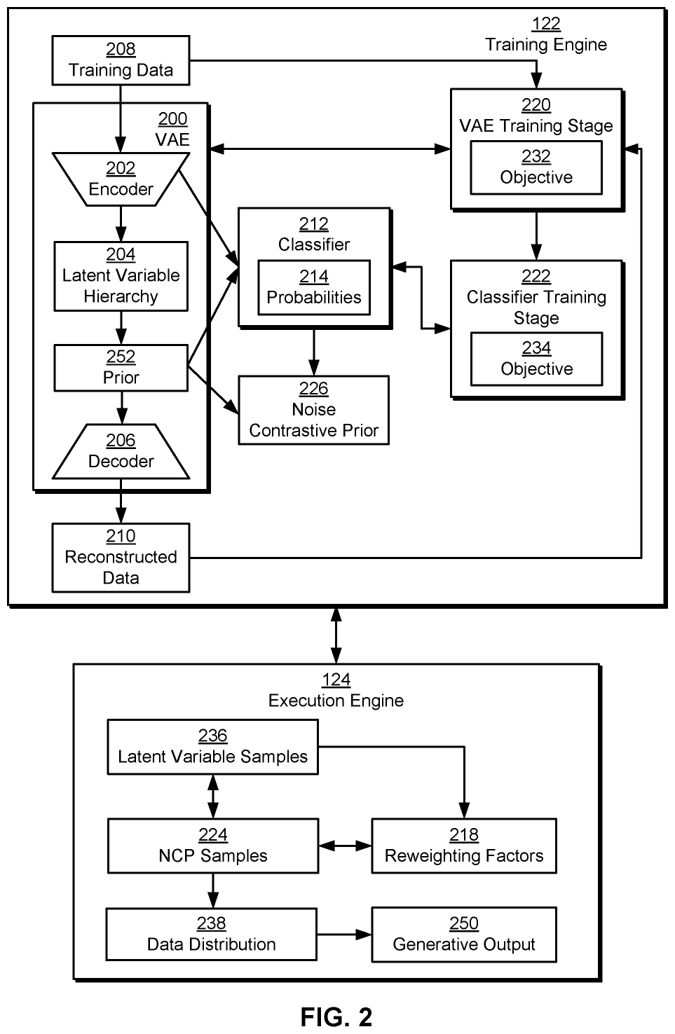

FIG. 2 is a more detailed illustration of training engine 122 and execution engine 124 of FIG. 1, according to various embodiments. Training engine 122 trains a VAE 200 that learns a distribution of a dataset of training data 208, and execution engine 124 executes one or more portions of VAE 200 to produce generative output 250 that includes additional data points in the distribution that are not found in training data 208.

As shown, VAE 200 includes a number of neural networks: an encoder 202, a prior 252, and a decoder 206. Encoder 202 “encodes” a set of training data 208 into latent variable values, prior 252 learns the distribution of latent variables outputted by encoder 202, and decoder 206 “decodes” latent variable values sampled from the distribution into reconstructed data 210 that substantially reproduces training data 208. For example, training data 208 could include images of human faces, animals, vehicles, and/or other types of objects; speech, music, and/or other audio; articles, posts, written documents, and/or other text; 3D point clouds, meshes, and/or models; and/or other types of content or data. When training data 208 includes images of human faces, encoder 202 could convert pixel values in each image into a smaller number of latent variables representing inferred visual attributes of the objects and/or images (e.g., skin tones, hair colors and styles, shapes and sizes of facial features, gender, facial expressions, and/or other characteristics of human faces in the images), prior 252 could learn the means and variances of the distribution of latent variables across multiple images in training data 208, and decoder 206 could convert latent variables sampled from the latent variable distribution and/or outputted by encoder 202 into reconstructions of images in training data 208.

The generative operation of VAE 200 may be represented using the following probability model:

p(x,z)=p(z)p(x|z), (1)

where p(z) is a prior distribution learned by prior 252 over latent variables z and p(x|z) is the likelihood function, or decoder 206, that generates data x given latent variables z. In other words, latent variables are sampled from prior 252 p(z), and the data x has a likelihood that is conditioned on the sampled latent variables z. The probability model includes a posterior p(z|x), which is used to infer values of the latent variables z. Because p(z|x) is intractable, another distribution q(z|x) learned by encoder 202 is used to approximate p(z|x).

As shown, training engine 122 performs a VAE training stage 220 that updates parameters of encoder 202, prior 252, and decoder 206 based on an objective 232 that is calculated based on the probability model representing VAE 200 and an error between training data 208 (e.g., a set of images, text, audio, video, etc.) and reconstructed data 210. In particular, objective 232 includes a variational lower bound on the log-likelihood p(x) to be maximized:

$$log p ( x ) \geq \text{?} [ log p ( x \vert z ) ] - KL ( q ( z \vert x ) \vert \vert p ( x ) ) \text{:} = {ℒ}_{VAE} ( x ) , \\ \text{?} \text{indicates text missing or illegible when filed} \qquad ( 2 )$$

where q(z|x) is the approximate posterior learned by encoder 202 and KL is the Kullback-Leibler (KL) divergence. The final training objective is formulated as [symbol] ₚ_{_{d}}₍ₓ₎[ [symbol] _{VAE}(x)], where p_{d}(x) is the distribution of training data 208.

Those skilled in the art will appreciate that prior 252 may fail to match the aggregate approximate posterior distribution outputted by encoder 202 from training data 208 after VAE training stage 220 is complete. In particular, the aggregate approximate posterior can be denoted by q(z) [symbol] [symbol] ₚ_{_{d}}₍ₓ₎[q(z|x)]. During VAE training stage 220, maximizing [symbol] [symbol] [symbol] [symbol] with respect to the parameters of prior 252 corresponds to bringing prior 252 as close as possible to the aggregate approximate posterior by minimizing KL(q(z)∥p(z)) with respect to p(z). However, prior 252 p(z) is unable to exactly match the aggregate approximate posterior q(z) at the end of VAE training stage 220 (e.g., because prior 252 is not expressive enough to capture the aggregate approximate posterior). Because of this mismatch, the distribution of latent variables learned by prior 252 from training data 208 assigns high probabilities to regions in the latent space occupied by latent variables z that do not correspond to any samples in training data 208. In turn, decoder 206 is unable to convert samples from these regions into data that meaningfully resembles or reflects the attributes of any training data 208.

In one or more embodiments, training engine 122 mitigates mismatch between the aggregate approximate posterior distribution learned by encoder 202 and the prior distribution encoded by prior 252 at the end of VAE training stage 220 by creating a noise contrastive prior (NCP) 226 that adjusts samples from prior 252 to avoid regions in the latent space that do not correspond to samples in training data 208. In some embodiments, NCP 226 includes the following form:

p_{NCP}(z)=(r(z)p(z))/Z, (3)

where p(z) is a base prior 252 distribution (e.g., a Gaussian distribution), r(z) is a reweighting factor (e.g., reweighting factors 218), and Z=∫r(z)p(z)dz is a normalization constant. The function r maps an n-dimensional real-valued latent variable z to a positive scalar.

As shown, NCP 226 is created using a combination of prior 252 and a classifier 212 that outputs probabilities 214 related to output of encoder 202 and prior 252. More specifically, classifier 212 includes a binary classifier that analyzes latent variable samples from VAE 200 and determines whether the samples are from encoder 202 (e.g., after corresponding samples of training data 208 are inputted into encoder 202) or from prior 252.

To create NCP 226, training engine 122 freezes the parameters of encoder 202, prior 252, and decoder 206 in VAE 200 after VAE training stage 220 is complete and performs a classifier training stage 222 that trains classifier 212 to distinguish between a first set of latent variable values generated by encoder 202 from training data 208 and a second set of latent variable values sampled from prior 252. For example, classifier 212 could include a residual neural network, tree-based model, logistic regression model, support vector machine, and/or another type of machine learning model. Input into classifier 212 could include a set of latent variable values from the latent space of VAE 200, and output from classifier 212 could include two probabilities 214 that sum to 1: a first probability representing the likelihood that the set of latent variable values is generated by encoder 202, and a second probability representing the likelihood that the set of latent variable values is sampled from prior 252.

In one or more embodiments, classifier 212 is trained using an objective 234 that includes a binary cross-entropy loss:

$${min}_{D} - \text{?} [ log D ( z ) ] - \text{?} [ log ( 1 - D ( z ) ) ] . \\ \text{?} \text{indicates text missing or illegible when filed} \qquad ( 4 )$$

In the above equation, D: [symbol] ⁿ→(0,1) is a binary classifier 212 that generates classification probabilities 214 that distinguish between samples from encoder 202 and samples from prior 252. Equation 4 is minimized when

$$D ( z ) = \frac{\text{?} ( \text{?} )}{\text{?} ( \text{?} ) + \text{?} ( \text{?} )} . \\ \text{?} \text{indicates text missing or illegible when filed}$$

Denoting an optimal classifier 212 by D*(z), the reweighting factor is estimated as:

$$r ( z ) = \frac{g ( x )}{p ( x )} \approx \frac{{D}^{*} ( x )}{1 - {D}^{*} ( x )} \qquad ( 5 )$$

After both VAE training stage 220 and classifier training stage 222 are complete, training engine 122 and/or another component of the system create NCP 226 from prior 252 and classifier 212. For example, training engine 122 could use Equation 3 to replace the base prior 252 with a more expressive distribution of the form p_{NCP}(z)∝r(z)p(z). In turn, NCP 226 uses the reweighting factor r(z) to match prior 252 to the aggregate approximate posterior, thereby avoiding regions in the latent space associated with z that do not correspond to encoded attributes of training data 208.

After VAE training stage 220 and classifier training stage 222 are complete and NCP 226 is created, execution engine 124 uses NCP 226 and/or one or more portions of VAE 200 to produce generative output 250 that is not found in the set of training data 208. In particular, execution engine 124 uses latent variable samples 236 from the distribution of latent variables learned by prior 252 and corresponding reweighting factors 218 generated using classifier 212 to generate NCP samples 224 from NCP 226. Execution engine 124 then uses NCP samples 224 to generate a data distribution 238 as output of decoder 206 and subsequently samples from data distribution 238 to produce generative output 250.

For example, execution engine 124 could obtain a set of latent variable samples 236 as values of latent variables that are sampled from the distribution described by parameters (e.g., means and variances) outputted by prior 252, after VAE 200 is trained on training data 208 that includes images of human faces. Execution engine 124 could apply classifier 212 to latent variable samples 236 to generate probabilities 214 as one or more values between 0 and 1 and use Equation 5 to convert probabilities 214 into one or more reweighting factors 218. Execution engine 124 could use reweighting factors 218 to convert latent variable samples 236 into NCP samples 224 from NCP 226 and apply decoder 206 to NCP samples 224 to obtain parameters of data distribution 238 corresponding to the likelihood p(x|z) (e.g., the distribution of pixel values for individual pixels in an image, given NCP samples 224). Execution engine 124 could then sample from the likelihood parameterized by decoder 206 to produce generative output 250 that includes an image of a human face. Because latent variable samples 236 and NCP samples 224 are obtained from a continuous latent space representation, execution engine 124 could further interpolate between visual attributes represented by the latent variables (e.g., generating smooth transitions between angry and happy facial expressions represented by one or more latent variables) to generate images of human faces that are not found in training data 208.

Execution engine 124 includes functionality to generate NCP samples 224 from NCP 226 using a variety of techniques. First, execution engine 124 may use a sampling-importance-resampling (SIR) technique to generate NCP samples 224 based on latent variable samples 236 and reweighting factors 218. In the SIR technique, execution engine 124 generates M samples from prior 252 {z [symbol] } [symbol] −p(z). Execution engine 124 then resamples one of the M proposed samples using importance weights that are calculated using reweighting factors 218:

w^{(m)}=p_{NCP}(z^{(m)})/p(z^{(m)})=r(z^{(m)}), (6)

where each importance weight w^{(m)} is proportional to the probability of resampling the corresponding sample from the M original samples. Because SIR is non-iterative, execution engine 124 can generate sample proposals from prior 252 and evaluate r on the sample proposals in parallel.

Second, execution engine 124 may use a sampling technique based on Langevin Dynamics (LD) to generate NCP samples 224 from latent variable samples 236 and reweighting factors 218. This LD-based sampling technique is performed using the following energy function:

E(z)=−log r(z)−log p(z) (7)

During LD-based sampling, execution engine 124 initializes a sample z₀ by drawing from prior 252 p(z) and iteratively updates the sample using the following:

zₜ₊₁=zₜ−0.5λ∇_{z}E(z)+\sqrt{λ}εₜ, (8)

where εₜ˜N(0, 1) and λ is the step size. After LD is run for a finite number of iterations, the initial sample is converted into a corresponding NCP sample.

In some embodiments, VAE 200 is a hierarchical VAE that uses deep neural networks for encoder 202, prior 252, and decoder 206. The hierarchical VAE includes a latent variable hierarchy 204 that partitions latent variables into a sequence of disjoint groups. Within latent variable hierarchy 204, a sample from a given group of latent variables is combined with a feature map and passed to the following group of latent variables in the hierarchy for use in generating a sample from the following group.

Continuing with the probability model represented by Equation 1, partitioning of the latent variables may be represented by z={z₁, z₂, . . . , z_{K}}, where K is the number of groups. Within latent variable hierarchy 204, prior 252 is represented by p(z)=Πₖ p(zₗ|z_{<k}), and the approximate posterior is represented by q(z|x)=Πₖ q(zₖ|z_{<k}, x), where each conditional p(zₗ|z_{<k}) in the prior and each conditional q(zₖ|z_{<k}, x) in the approximate posterior can be represented by factorial Normal distributions. In addition, a(z_{>k}) [symbol] [symbol] [symbol] [x]{q(z_{<K}|x)} is the aggregate approximate posterior up to the (k−1)th group, and q{zₖ|z_{<k}} [symbol] [symbol] [symbol] [q{zₖ|z_{<k},x}] is the aggregate conditional distribution for the kth group.

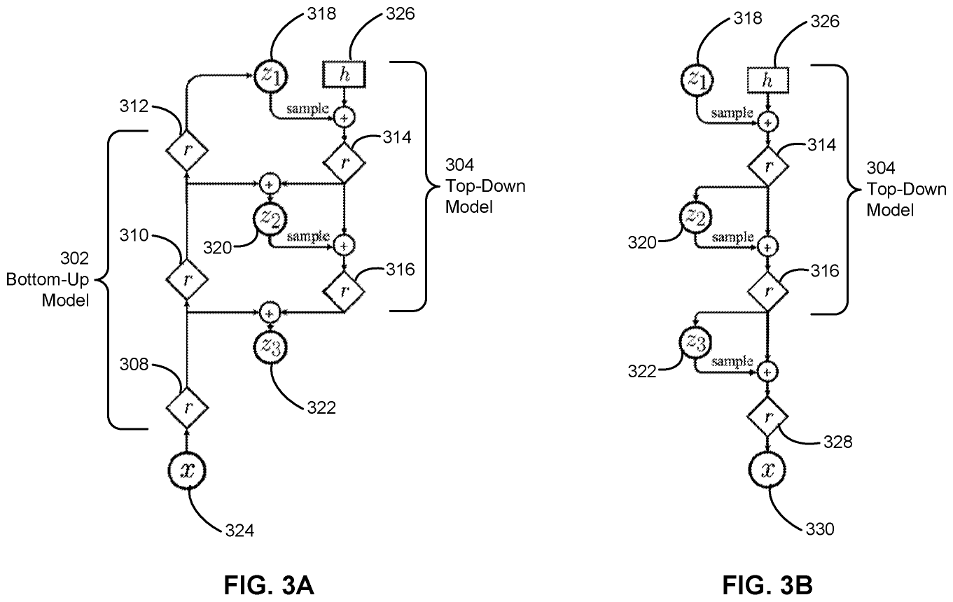

In some embodiments, encoder 202 includes a bottom-up model and a top-down model that perform bidirectional inference of the groups of latent variables based on training data 208. The top-down model is then reused as prior 252 to infer latent variable values that are inputted into decoder 206 to produce reconstructed data 210 and/or generative output 250. The architectures of encoder 202 and decoder 206 are described in further detail below with respect to FIGS. 3A-3B.

When VAE 200 is a hierarchical VAE that includes latent variable hierarchy 204, objective 232 includes an evidence lower bound to be maximized with the following form:

$$\text{?} ( x ) := \text{?} [ log p ( x \vert z ) ] - {\sum }_{k = 1}^{K} \text{?} [ KL ( q ( \text{?} \vert \text{?} , x ) \vert \vert p ( {z}_{k} \vert \text{?} ) ) ] , \\ \text{?} \text{indicates text missing or illegible when filed} \qquad ( 9 )$$

where q(z_{<k}|x)=Π [symbol] q(z [symbol] ,x) is the approximate posterior up to the (k−1)th group. In addition, log p(x|z) is the log-likelihood of observed data x given the sampled latent variables z; this term is maximized when p(x|z) assigns high probability to the original data x (i.e., when decoder 206 tries to reconstruct a data point x in training data 208 given latent variables z generated by encoder 202 from the data point). The “KL” terms in the equation represent KL divergences between the posteriors at different levels of latent variable hierarchy 204 and the corresponding priors (e.g., as represented by prior 252). Each KL(q(zₖ|z_{<k},x)∥p(zₖ|z_{<k})) can be considered the amount of information encoded in the kth group. The reparametrization trick may be used to backpropagate with respect to parameters of encoder 202 through objective 232.

In one or more embodiments, NCP 226 for a hierarchical VAE 200 with latent variable hierarchy 204 includes a hierarchical NCP 226 that is defined as:

$${p}_{NCP} ( z ) = \frac{1}{2} {\prod }_{k = 1}^{K} r ( {z}_{k} \vert {z}_{< k} ) p ( {z}_{k} \vert {z}_{< k} ) , \qquad ( 12 )$$

where each factor is an energy-based model (EBM). During training of the hierarchical VAE 200, training engine 122 initially performs VAE training stage 220 with prior 252 Π [symbol] p(zₖ|z_{<k}) and objective 232 represented by Equation 8. Training engine 122 then performs classifier training stage 222 with the parameters of the hierarchical VAE 200 frozen.

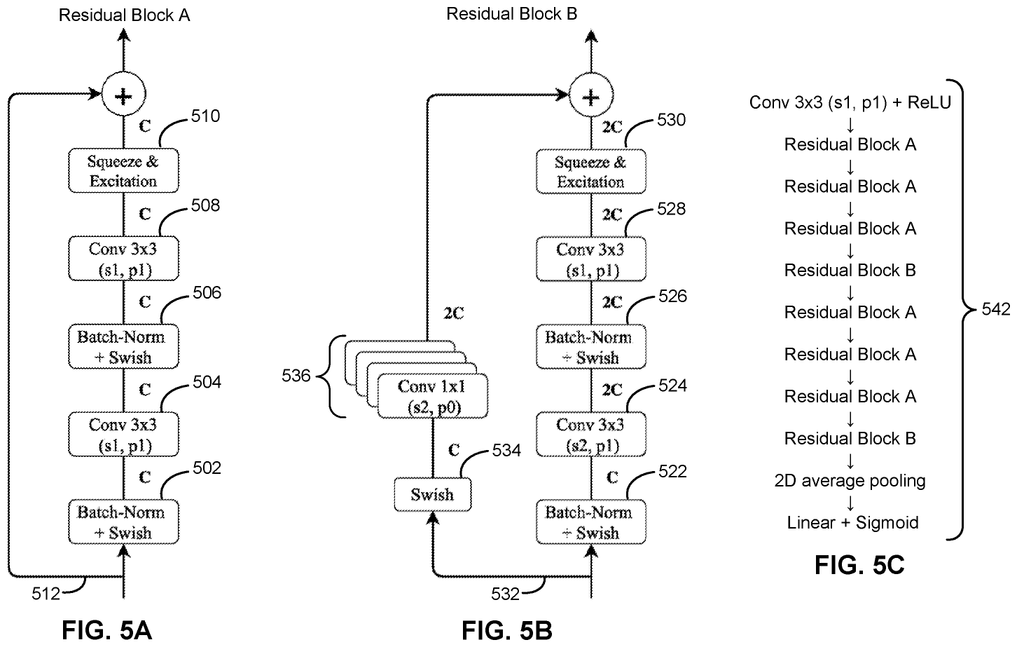

During classifier training stage 222 for a hierarchical NCP 226, training engine 122 trains multiple classifiers, where the number of classifiers is equal to the number of latent variable groups in latent variable hierarchy 204 and each classifier is assigned to a corresponding group of latent variables in latent variable hierarchy 204. Each classifier is additionally trained to distinguish between values from the assigned latent variable group generated by encoder 202 and values sampled from the assigned latent variable group in prior 252. Each classifier may further use one or more residual neural networks to predict whether a sample from a corresponding latent variable group comes from prior 252 or from encoder 202, as described in further detail below with respect to FIGS. 5A-5C.

More specifically, each classifier is trained using the following objective 234:

$$\text{?} \text{?} [ - \text{?} [ log {D}_{k} ( {z}_{k} , c ( {z}_{< k} ) ) ] - \text{?} [ log ( 1 - {D}_{k} ( {z}_{k} , c ( {z}_{< k} ) ) ) ] ] , \\ \text{?} \text{indicates text missing or illegible when filed} \qquad ( 13 )$$

where the outer expectation samples from groups up to the (k−1)th group and the inner expectations sample from the approximate posterior outputted by encoder 202 and base prior 252 for the kth group, respectively, conditioned on the same z_{<k}. Each classifier Dₖ classifies samples zₖ while conditioning its prediction on z_{<k} using a shared context feature c(z_{<k}). This shared context feature can include one or more previous latent variable group samples Z<k and/or a representation extracted from z_{<k}.

Objective 234 as represented by Equation 13 is minimized when

$${D}_{k} ( {z}_{k} , c ( {z}_{< k} ) ) = \frac{\text{?} ( {z}_{k} \vert {z}_{< k} )}{\text{?} ( {z}_{k} \vert {z}_{< k} ) + p ( {z}_{k} \vert {z}_{< k} )} . \\ \text{?} \text{indicates text missing or illegible when filed}$$

Denoting an optimal classifier 212 by D*(z, c(z_{<k})), the reweighting factor for the hierarchical NCP 226 is obtained as:

$$r ( {z}_{k} \vert {z}_{< k} ) \approx \frac{\text{?} ( \text{?} ( \text{?} ) )}{1 - \text{?} ( \text{?} ( \text{?} ) )} \\ \text{?} \text{indicates text missing or illegible when filed} \qquad ( 14 )$$

After the hierarchical VAE 200 and corresponding hierarchical NCP 226 are trained, execution engine 124 uses ancestral sampling to generate latent variable samples 236 from prior 252 and SIR or LD to generate NCP samples 224 from each group in latent variable hierarchy 204. One or more latent variable groups from NCP samples 224 are then inputted into decoder 206 to produce data distribution 238 and corresponding generative output 250, as discussed above.

FIG. 3A is an exemplar architecture for encoder 202 in the hierarchical version of VAE 200 of FIG. 2, according to various embodiments. As shown, the example architecture forms a bidirectional inference model that includes a bottom-up model 302 and a top-down model 304.

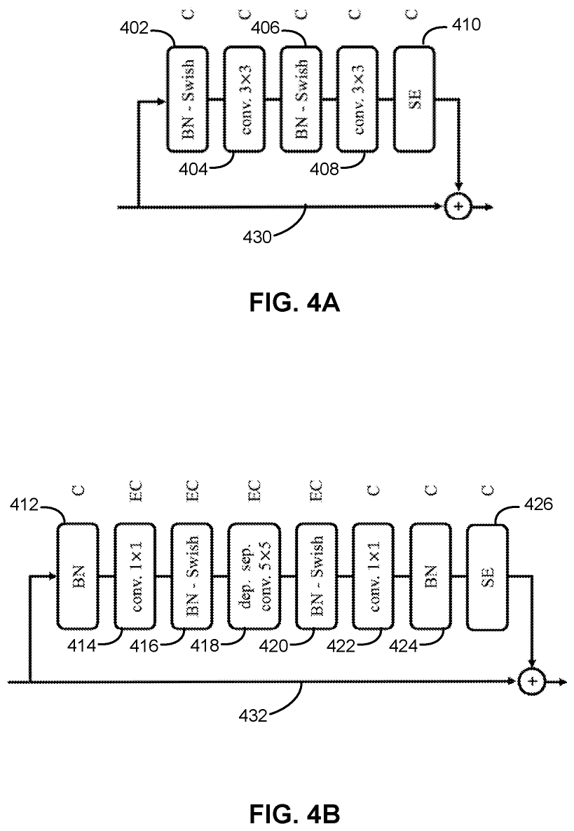

Bottom-up model 302 includes a number of residual networks 308-312, and top-down model 304 includes a number of additional residual networks 314-316 and a trainable parameter 326. Each of residual networks 308-316 includes one or more residual cells, which are described in further detail below with respect to FIGS. 4A and 4B.

Residual networks 308-312 in bottom-up model 302 deterministically extract features from an input 324 (e.g., an image) to infer the latent variables in the approximate posterior (e.g., q(z|x) in the probability model for VAE 200). In turn, components of top-down model 304 are used to generate the parameters of each conditional distribution in latent variable hierarchy 204. After latent variables are sampled from a given group in latent variable hierarchy 204, the samples are combined with feature maps from bottom-up model 302 and passed as input to the next group.

More specifically, a given data input 324 is sequentially processed by residual networks 308, 310, and 312 in bottom-up model 302. Residual network 308 generates a first feature map from input 324, residual network 310 generates a second feature map from the first feature map, and residual network 312 generates a third feature map from the second feature map. The third feature map is used to generate the parameters of a first group 318 of latent variables in latent variable hierarchy 204, and a sample is taken from group 318 and combined (e.g., summed) with parameter 326 to produce input to residual network 314 in top-down model 304. The output of residual network 314 in top-down model 304 is combined with the feature map produced by residual network 310 in bottom-up model 302 and used to generate the parameters of a second group 320 of latent variables in latent variable hierarchy 204. A sample is taken from group 320 and combined with output of residual network 314 to generate input into residual network 316. Finally, the output of residual network 316 in top-down model 304 is combined with the output of residual network 308 in bottom-up model 302 to generate parameters of a third group 322 of latent variables, and a sample may be taken from group 322 to produce a full set of latent variables representing input 324.

While the example architecture of FIG. 3A is illustrated with a latent variable hierarchy of three latent variable groups 318-322, those skilled in the art will appreciate that encoder 202 may utilize a different number of latent variable groups in the hierarchy, different numbers of latent variables in each group of the hierarchy, and/or varying numbers of residual cells in residual networks. For example, latent variable hierarchy 204 for an encoder that is trained using 28×28 pixel images of handwritten characters may include 15 groups of latent variables at two different “scales” (i.e. spatial dimensions) and one residual cell per group of latent variables. The first five groups have 4×4×20-dimensional latent variables (in the form of height×width×channel), and the next ten groups have 8×8×20-dimensional latent variables. In another example, latent variable hierarchy 204 for an encoder that is trained using 256×256 pixel images of human faces may include 36 groups of latent variables at five different scales and two residual cells per group of latent variables. The scales include spatial dimensions of 8×8×20, 16×16×20, 32×32×20, 64×64×20, and 128×128×20 and 4, 4, 4, 8, and 16 groups, respectively.

FIG. 3B is an exemplar architecture for a generative model in the hierarchical version of VAE 200 of FIG. 2, according to various embodiments. As shown, the generative model includes top-down model 304 from the exemplar encoder architecture of FIG. 3A, as well as an additional residual network 328 that implements decoder 206.

In the exemplar generative model architecture of FIG. 3B, the representation extracted by residual networks 314-316 of top-down model 304 is used to infer groups 318-322 of latent variables in the hierarchy. A sample from the last group 322 of latent variables is then combined with the output of residual network 316 and provided as input to residual network 328. In turn, residual network 328 generates a data output 330 that is a reconstruction of a corresponding input 324 into the encoder and/or a new data point sampled from the distribution of training data for VAE 200.

In some embodiments, top-down model 304 is used to learn a prior (e.g., prior 252 of FIG. 2) distribution of latent variables during training of VAE 200. The prior is then reused in the generative model and/or NCP 226 to sample from groups 318-322 of latent variables before some or all of the samples are converted by decoder 206 into generative output. This sharing of top-down model 304 between encoder 202 and the generative model reduces computational and/or resource overhead associated with learning a separate top-down model for prior 252 and using the separate top-down model in the generative model. Alternatively, VAE 200 may be structured so that encoder 202 uses a first top-down model to generate latent representations of training data 208 and the generative model uses a second, separate top-down model as prior 252.

FIG. 4A is an exemplar residual cell in encoder 202 of the hierarchical version of VAE 200 of FIG. 2, according to various embodiments. More specifically, FIG. 4A shows a residual cell that is used by one or more residual networks 308-312 in bottom-up model 302 of FIG. 3A. As shown, the residual cell includes a number of blocks 402-410 and a residual link 430 that adds the input into the residual cell to the output of the residual cell.

Block 402 is a batch normalization block with a Swish activation function, block 404 is a 3×3 convolutional block, block 406 is a batch normalization block with a Swish activation function, block 408 is a 3×3 convolutional block, and block 410 is a squeeze and excitation block that performs channel-wise gating in the residual cell (e.g., a squeeze operation such as mean that obtains a signal value for each channel, followed by an excitation operation that applies a non-linear transformation to the output of the squeeze operation to produce per-channel weights). In addition, the same number of channels is maintained across blocks 402-410. Unlike conventional residual cells with a convolution-batch normalization-activation ordering, the residual cell of FIG. 4A includes a batch normalization-activation-convolution ordering, which may improve the performance of bottom-up model 302 and/or encoder 202.

FIG. 4B is an exemplar residual cell in a generative model of the hierarchical version of VAE 200 of FIG. 2, according to various embodiments. More specifically, FIG. 4B shows a residual cell that is used by one or more residual networks 314-316 in top-down model 304 of FIGS. 3A and 3B. As shown, the residual cell includes a number of blocks 412-426 and a residual link 432 that adds the input into the residual cell to the output of the residual cell.

Block 412 is a batch normalization block, block 414 is a 1×1 convolutional block, block 416 is a batch normalization block with a Swish activation function, block 418 is a 5×5 depthwise separable convolutional block, block 420 is a batch normalization block with a Swish activation function, block 422 is a 1×1 convolutional block, block 424 is a batch normalization block, and block 426 is a squeeze and excitation block. Blocks 414-420 marked with “EC” indicate that the number of channels is expanded “E” times, while blocks marked with “C” include the original “C” number of channels. In particular, block 414 performs a 1×1 convolution that expands the number of channels to improve the expressivity of the depthwise separable convolutions performed by block 418, and block 422 performs a 1×1 convolution that maps back to “C” channels. At the same time, the depthwise separable convolution reduces parameter size and computational complexity over regular convolutions with increased kernel sizes without negatively impacting the performance of the generative model.

Moreover, the use of batch normalization with a Swish activation function in the residual cells of FIGS. 4A and 4B may improve the training of encoder 202 and/or the generative model over conventional residual cells or networks. For example, the combination of batch normalization and the Swish activation in the residual cell of FIG. 4A improves the performance of a VAE with 40 latent variable groups by about 5% over the use of weight normalization and an exponential linear unit activation in the same residual cell.

FIG. 5A is an exemplar residual block in a classifier (e.g., classifier 212) that can be used with the hierarchical version of VAE 200 of FIG. 2, according to various embodiments. More specifically, FIG. 5A shows a residual block named “Residual Block A,” which is included in a classifier that is trained to predict the probability that a corresponding group of latent variables in latent variable hierarchy 204 is generated by encoder 202 from training data 208 and/or sampled from prior 252. As shown, the residual block includes a number of blocks 502-510 (which can also be referred to as layers) and a residual link 512 that adds the input into the residual block to the output of the residual block.

Block 502 is a batch normalization block with a Swish activation function, block 504 is a 3×3 convolutional block, block 506 is a batch normalization block with a Swish activation function, block 508 is a 3×3 convolutional block, and block 510 is a squeeze and excitation block. All blocks 502-510 in FIG. 5A are marked with “C,” indicating that the original “C” number of channels is maintained in feature maps outputted by all blocks 502-510 and by the residual block. In addition, the values of “s1” and “p1” associated with the 3×3 convolutional blocks 504 and 508 represent stride and padding parameters that are both set to 1.

FIG. 5B is an exemplar residual block in a classifier (e.g., classifier 212) that can be used with the hierarchical version of VAE 200 of FIG. 2, according to various embodiments. More specifically, FIG. 5B shows a residual block named “Residual Block B,” which is included in a classifier that is trained to predict the probability that a corresponding group of latent variables in latent variable hierarchy 204 is generated by encoder 202 from training data 208 and/or sampled from prior 252. As shown, the residual block includes a number of blocks 522-530 (which can also be referred to as layers), a residual link 532 that adds the input into the residual block to the output of the residual block, and a number of additional blocks 534-536 (which can also be referred to as layers) along residual link 532.

Block 522 is a batch normalization block with a Swish activation function, block 524 is a 3×3 convolutional block, block 526 is a batch normalization block with a Swish activation function, block 528 is a 3×3 convolutional block, and block 530 is a squeeze and excitation block. Block 534 is a swish activation function, and block 536 includes a sequence of 1×1 convolutional kernels that are a factorization of a larger convolutional kernel.

The value of “C” after blocks 522 and 534 indicate that the original “C” number of channels is outputted by blocks 522 and 534, and the value of “2C” after blocks 524-530 and 536 indicate that twice the original “C” number of channels is outputted in feature maps for blocks 524-530 and 536 and by the residual block. The values of “s2” and “p1” associated with the first 3×3 convolutional block 524 indicate that block 524 has a stride of 2 and padding of 1, the values of “s1” and “p1” associated with the second 3×3 convolutional block 528 indicate that block 528 has a stride of 1 and a padding of 1, and the values of “s2” and “p0” associated with the series of 1×1 convolutional kernels in block 536 indicate that each 1×1 convolution has a stride of 2 and a padding of 0.

FIG. 5C is an exemplar architecture 542 for a classifier that can be used with the hierarchical version of VAE 200 of FIG. 2, according to various embodiments. As shown, architecture 542 begins with a 3×3 convolutional kernel with a rectified linear unit (ReL) activation function, a stride of 1, and a padding of 1. The 3×3 convolution is followed by eight residual blocks: three instances of residual block A followed by one instance of residual block B, followed by three instances of residual block A, followed by one instance of residual block B. The structure of residual block A is described above with respect to FIG. 5A, and the structure of residual block B is described above with respect to FIG. 5B. The residual blocks are followed by a 2D average pooling layer, which in turn is followed by a final layer with a linear portion that combines the activations from the previous layer with corresponding weights and/or a bias and a sigmoid activation function.

Although classifier 212 and NCP 226 have been described above with respect to VAE 200, it will be appreciated that classifier 212 and NCP 226 can also be used to improve the generative output of other types of generative models that include a prior distribution of latent variables in a latent space, a decoder that converts samples of the latent variables into samples in a data space of a training dataset, and a component or method that maps a sample in the training dataset to a sample in the latent space of the latent variables. In the context of VAE 200, the prior distribution is learned by prior 252, encoder 202 converts samples of training data in the data space into latent variables in the latent space associated with latent variable hierarchy 204, and decoder 206 is a neural network that is separate from encoder 202 and converts latent variable values from the latent space back into likelihoods in the data space.

A generative adversarial network (GAN) is another type of generative model that can be used with classifier 212 and NCP 226. The prior distribution in the GAN is represented by a Gaussian and/or another type of simple distribution, the decoder in the GAN is a generator network that converts a sample from the prior distribution into a sample in the data space of a training dataset, and the generator network can be numerically inverted to map samples in the training dataset to samples in the latent space of the latent variables.

A normalizing flow is another type of generative model that can be used with classifier 212 and NCP 226. As with the GAN, the prior distribution in a normalizing flow is implemented using a Gaussian and/or another type of simple distribution. The decoder in a normalizing flow is represented by a decoder network that relates the latent space to the data space using a deterministic and invertible transformation from observed variables in the data space to latent variables in the latent space. The inverse of the decoder network in the normalizing flow can be used to map a sample in the training dataset to a sample in the latent space.

With each of these types of generative models, a first training stage is used to train the generative model, and a second training stage is used to train classifier 212 to distinguish between latent variable values sampled from the prior distribution in the generative model and latent variable values that are mapped to data points in the training dataset. NCP 226 is then created by combining the prior distribution with a reweighting factor that is computed from the output of classifier 212. A SIR and/or LD technique can then be used to convert samples from the prior distribution for the generative model into samples from NCP 226. The decoder in the generative model can then be used to convert samples from NCP 226 into new data in the data space of the training dataset.

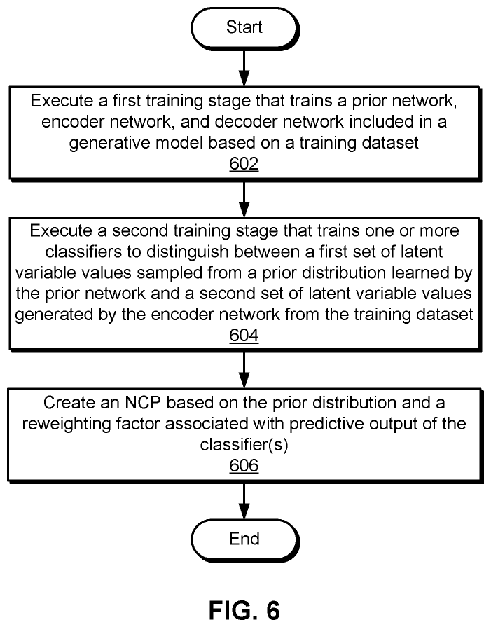

FIG. 6 is a flow diagram of method steps for training a generative model, according to various embodiments. Although the method steps are described in conjunction with the systems of FIGS. 1-5, persons skilled in the art will understand that any system configured to perform the method steps in any order falls within the scope of the present disclosure.

As shown, training engine 122 executes 602 a first training stage that trains a prior network, encoder network, and decoder network included in a generative model based on a training dataset. For example, training engine 124 could input a set of training images that have been scaled to a certain resolution into a hierarchical VAE (or another type of generative model that includes a distribution of latent variables). The training images may include human faces, animals, vehicles, and/or other types of objects. Training engine 124 could also perform one or more operations that update parameters of the hierarchical VAE based on the output of the prior, encoder, and decoder networks and a corresponding objective function.

Next, training engine 122 executes 604 a classifier training stage that trains one or more classifiers to distinguish between a first set of latent variable values sampled from a prior distribution learned by the prior network and a second set of latent variable values generated by the encoder network from the training dataset. Continuing with the above example, training engine 122 could freeze the parameters of the hierarchical VAE at the end of the first training stage. Training engine 122 could then obtain the first set of latent variable values by sampling from the prior network and obtain the second set of latent variable values by applying the encoder network to a subset of the training images. Training engine 122 could then perform one or more operations that use a training technique (e.g., gradient descent and backpropagation), an objective function (e.g., binary cross-entropy loss), and/or one or more hyperparameters to iteratively update weights of each classifier so that probabilities outputted by the classifier (e.g., probabilities that a corresponding group of latent variable values in the latent variable hierarchy is generated by the prior or encoder) better match the corresponding labels.

At the end of the classifier training stage, training engine 122 produces a series of classifiers, where each classifier in the series distinguishes between latent variables values sampled from the prior network for a corresponding group in the latent variable hierarchy and latent variable values generated by the encoder network for the same group in the latent variable hierarchy. The classifier's predictions may additionally be based on a feature map that includes and/or represents latent variable values of previous groups in the latent variable hierarchy.

Training engine 122 then creates 606 an NCP based on the prior distribution and a reweighting factor associated with the predictive output of the classifier(s). For example, training engine 122 could combine the prior network and the classifier(s) into the NCP. The NCP converts one or more probabilities outputted by the classifier(s) into a reweighting factor that is used to adjust latent variable samples for each latent variable group produced using the prior network, as discussed above.

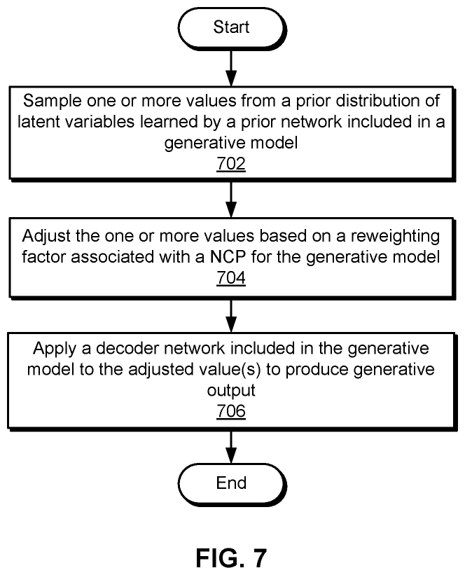

FIG. 7 is a flow diagram of method steps for producing generative output, according to various embodiments. Although the method steps are described in conjunction with the systems of FIGS. 1-5, persons skilled in the art will understand that any system configured to perform the method steps in any order falls within the scope of the present disclosure.

As shown, execution engine 124 samples 702 one or more values from a prior distribution of latent variables learned by a prior network included in a generative model (e.g., VAE, normalizing flow, GAN, etc.). For example, execution engine 124 could use an ancestral sampling technique to sample from multiple groups of latent variables in a latent variable hierarchy learned by the prior network in a hierarchical VAE. After a first value is sampled from a given group in the hierarchy of latent variables, a second value is sampled from the next group in the hierarchy of latent variables based on the first value and/or a feature map generated from the first value. In other words, sampling of a given latent variable group in the hierarchy is conditioned on samples of previous groups in the hierarchy.

Next, execution engine 124 adjusts 704 the one or more values based on a reweighting factor associated with an NCP for the generative model. For example, execution engine 124 could apply the reweighting factor to the one or more values sampled in operation 702 to shift the value(s) towards one or more other values of the latent variables that have been generated by an encoder network in the generative model from a training dataset.

As mentioned above, the reweighting factor may be calculated using one or more probabilities outputted by one or more classifiers that learn to distinguish between a first set of values sampled from the prior distribution and a second set of latent variable values generated by an encoder network included in the generative model. Each classifier may include a residual neural network with one or more residual blocks (e.g., the residual blocks described above with respect to FIGS. 5A-5B). Each classifier may also distinguish between latent variable values sampled from a corresponding group in the latent variable hierarchy encoded in the prior network and latent variable values generated by the encoder network from a training dataset. The reweighting factor may be calculated based on a quotient of a probability that is outputted by the classifier(s) and a difference between the probability and one. The adjustment in operation 704 may be performed by resampling the latent variable value(s) based on importance weights that are proportional to reweighting factors for multiple samples of the prior distribution and/or iteratively updating the latent variable value(s) based on a gradient of an energy function associated with the prior distribution and the reweighting factor.

Execution engine 124 then applies 706 a decoder network included in the generative model to the adjusted value(s) to produce generative output. For example, the decoder network may output parameters of a likelihood function based on the adjusted value(s), and samples from the likelihood function may be obtained to produce the generative output (e.g., as pixel values of pixels in an image).

### Example Game Streaming System

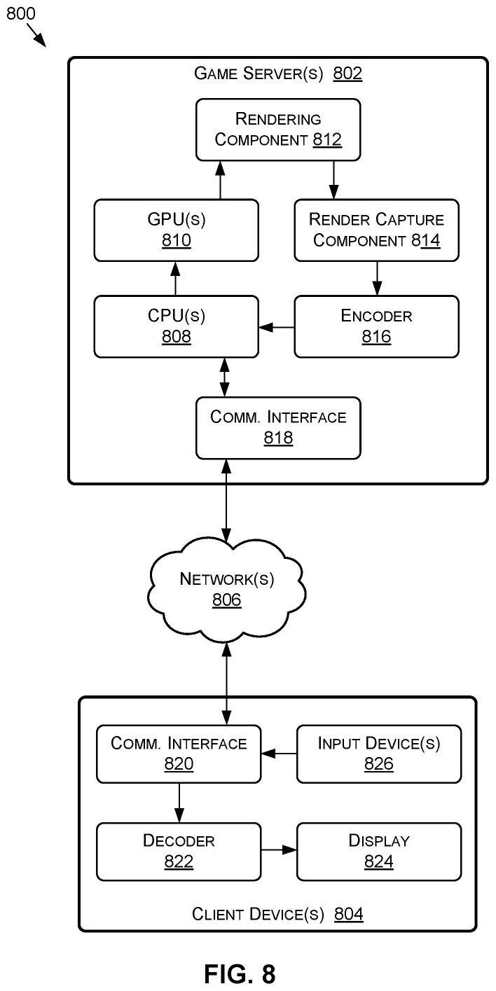

FIG. 8 is an example system diagram for a game streaming system 800, according to various embodiments. FIG. 8 includes game server(s) 802 (which may include similar components, features, and/or functionality to the example computing device 100 of FIG. 1), client device(s) 804 (which may include similar components, features, and/or functionality to the example computing device 100 of FIG. 1), and network(s) 806 (which may be similar to the network(s) described herein). In some embodiments, system 800 may be implemented using a cloud computing system and/or distributed system.

In system 800, for a game session, client device(s) 804 may only receive input data in response to inputs to the input device(s), transmit the input data to game server(s) 802, receive encoded display data from game server(s) 802, and display the display data on display 824. As such, the more computationally intense computing and processing is offloaded to game server(s) 802 (e.g., rendering—in particular ray or path tracing—for graphical output of the game session is executed by the GPU(s) of game server(s) 802). In other words, the game session is streamed to client device(s) 804 from game server(s) 802, thereby reducing the requirements of client device(s) 804 for graphics processing and rendering.

For example, with respect to an instantiation of a game session, a client device 804 may be displaying a frame of the game session on the display 824 based on receiving the display data from game server(s) 802. Client device 804 may receive an input to one or more input device(s) 826 and generate input data in response. Client device 804 may transmit the input data to the game server(s) 802 via communication interface 820 and over network(s) 806 (e.g., the Internet), and game server(s) 802 may receive the input data via communication interface 818. CPU(s) 308 may receive the input data, process the input data, and transmit data to GPU(s) 810 that causes GPU(s) 810 to generate a rendering of the game session. For example, the input data may be representative of a movement of a character of the user in a game, firing a weapon, reloading, passing a ball, turning a vehicle, etc. Rendering component 812 may render the game session (e.g., representative of the result of the input data), and render capture component 814 may capture the rendering of the game session as display data (e.g., as image data capturing the rendered frame of the game session). The rendering of the game session may include ray- or path-traced lighting and/or shadow effects, computed using one or more parallel processing units—such as GPUs 810, which may further employ the use of one or more dedicated hardware accelerators or processing cores to perform ray or path-tracing techniques—of game server(s) 802. Encoder 816 may then encode the display data to generate encoded display data and the encoded display data may be transmitted to client device 804 over network(s) 806 via communication interface 818. Client device 804 may receive the encoded display data via communication interface 820, and decoder 822 may decode the encoded display data to generate the display data. Client device 804 may then display the display data via display 824.

In some embodiments, system 800 includes functionality to implement training engine 122 and/or execution engine 124 of FIGS. 1-2. For example, one or more components of game server 802 and/or client device(s) 804 could execute training engine 122 to train a VAE and/or another generative model that includes an encoder network, a prior network, and/or a decoder network based on a training dataset (e.g., a set of images or models of characters or objects in a game). The executed training engine 122 may then train one or more classifiers to distinguish between a first set of values sampled from a prior distribution learned by the prior network and a second set of values of the set of latent variables generated by the encoder network from the training dataset. One or more components of game server 802 and/or client device(s) 804 may then execute inference engine 124 to produce generative output (e.g., additional images or models of characters or objects that are not found in the training dataset) by sampling from the prior distribution, adjusting the sampled values based on a reweighting factor associated with the output of the classifier(s), and applying the decoder network to the adjusted sampled values. The generative output may then be shown in display 824 during one or more game sessions on client device(s) 804.

In sum, the disclosed techniques improve generative output produced by VAEs and/or other types of generative models with distributions of latent variables. After a generative model is trained on a training dataset, a classifier is trained to distinguish between a first set of samples from a prior distribution of latent variables (e.g., visual attributes of faces or other objects in images) learned by the generative model and a second set of samples from an approximate aggregate posterior distribution of the latent variables associated with the training dataset (e.g., samples generated by an encoder portion of the generative model from a set of training images). The output of the classifier is used to calculate a reweighting factor for the prior distribution, and the reweighting factor is combined with the prior distribution into a noise-contrastive prior (NCP) for the generative model. The NCP brings the prior distribution closer to the approximate aggregate posterior, which allows samples from the NCP (e.g., samples from the prior distribution that are adjusted or selected based on the reweighting factor) to avoid “holes” in the prior distribution that do not correspond to data samples in the training dataset. A given sample from the NCP is then inputted into a decoder portion of the generative model to produce generative output that incorporates attributes extracted from the training dataset but that is not found in the training dataset.

At least one technical advantage of the disclosed techniques relative to the prior art is that the disclosed techniques produce generative output that looks more realistic and similar to the data in a training dataset compared to what is typically produced using conventional variational autoencoders (or other types of generative models that learn distributions of latent variables). Another technical advantage is that, with the disclosed techniques, a complex distribution of latent variables produced by an encoder from a training dataset can be approximated by a machine learning model that is trained and executed in a more computationally efficient manner relative to prior art techniques. These technical advantages provide one or more technological improvements over prior art approaches.

1. In some embodiments, a computer-implemented method for creating a generative model comprises performing one or more operations based on a plurality of training images to generate a trained encoder network and a trained prior network, wherein the trained encoder network converts each image included in the plurality of training images into a set of visual attributes, and the trained prior network learns a distribution of the set of visual attributes across the plurality of training images, performing one or more operations to train one or more classifiers to distinguish between values for the set of visual attributes generated by the trained encoder network and values for the set of visual attributes selected from the distribution learned by the trained prior network, and combining the trained prior network and the one or more classifiers to produce a trained prior component that is included in the generative model, wherein, in operation, the trained prior component produces one or more values for the set of visual attributes in order to generate a new image that is not included in the plurality of training images.

2. The computer-implemented method of clause 1, wherein combining the trained prior network and the one or more classifiers comprises combining one or more first values selected from the distribution learned by the trained prior network with a reweighting factor that is based on the one or more first values.

3. The computer-implemented method of clauses 1 or 2, wherein the new image comprises at least one face.

4. In some embodiments, a computer-implemented method for creating a generative model comprises performing one or more operations based on a training dataset to generate a trained encoder network and a trained prior network, wherein the trained encoder network converts a plurality of data points included in the training dataset into a set of latent variables, and the trained prior network learns a distribution of the set of latent variables across the training dataset, performing one or more operations to train one or more classifiers to distinguish between values for the set of latent variables generated via the trained encoder network and values sampled from the distribution learned by the trained prior network, and creating a trained prior component based on the trained prior network and one or more classifiers, wherein the trained prior component applies a reweighting factor to one or more first values sampled from the distribution learned by the trained prior network to generate one or more second values for the set of latent variables, wherein, in operation, the trained prior component produces the one or more second values in order to generate a new data point that is not included in the training dataset.

5. The computer-implemented method of clause 4, wherein the distribution learned by the trained prior network comprises a hierarchy of latent variables, and wherein the one or more first values are sampled from the distribution learned by the trained prior network by sampling one first value from a first group of latent variables included in the hierarchy of latent variables, and sampling another first value from a second group of latent variables included in the hierarchy of latent variables based on the first value and a feature map.

6. The computer-implemented method of clauses 4 or 5, wherein the one or more classifiers comprise a first classifier that distinguishes between a third value sampled from the first group of latent variables using the trained prior network and a fourth value for the first group of latent variables generated by the trained encoder network, and a second classifier that distinguishes between a fifth value sampled from the second group of latent variables using the trained prior network and a sixth value for the second group of latent variables generated by the trained encoder network.

7. The computer-implemented method of any of clauses 4-6, wherein the reweighting factor is applied to the one or more first values by resampling the one or more first values based on importance weights that are proportional to the reweighting factor.

8. The computer-implemented method of any of clauses 4-7, wherein the reweighting factor is applied to the one or more first values by iteratively updating the one or more first values based on a gradient of an energy function associated with the distribution learned by the trained prior network and the reweighting factor.

9. The computer-implemented method of any of clauses 4-8, wherein at least one of the one or more classifiers comprises a residual neural network.

10. The computer-implemented method of any of clauses 4-9, wherein the residual neural network includes a first batch normalization layer having a first Swish activation function, a first convolutional layer, a second batch normalization layer having a second Swish activation function, a second convolutional layer, and a squeeze and excitation layer.

11. The computer-implemented method of any of clauses 4-10, wherein the residual neural network includes a Swish activation function and a sequence of convolutional kernels.

12. The computer-implemented method of any of clauses 4-11, further comprising calculating the reweighting factor based on output generated by the one or more classifiers from the one or more first values.

13. The computer-implemented method of any of clauses 4-12, wherein performing the one or more operations to train the one or more classifiers comprises iteratively updating weights of the one or more classifiers based on a binary cross-entropy loss.

14. In some embodiments, a non-transitory computer readable medium stores instructions that, when executed by a processor, cause the processor to perform the steps of performing one or more operations based on a training dataset to train a generative model, wherein the generative model includes a first component that converts a plurality of data points included in the training dataset into a set of latent variables and a second component that generates a prior distribution of the set of latent variables across the training dataset, performing one or more operations to train one or more classifiers to distinguish between values for the set of latent variables generated via the first component and values sampled from the prior distribution, and creating a trained prior component based on the second component and one or more classifiers, wherein the trained prior component applies a reweighting factor to one or more first values sampled from the prior distribution to generate one or more second values for the set of latent variables, wherein the reweighting factor is determined based on output generated by the one or more classifiers from the one or more first values, wherein, in operation, the trained prior component produces the one or more second values in order to generate a new data point that is not included in the training dataset.

15. The non-transitory computer readable medium of clause 14, wherein the instructions further cause the processor to perform the steps of performing one or more decoding operations on the one or more second values via a decoder network included in the generative model to generate the new data point.

16. The non-transitory computer readable medium of clauses 14 or 15, wherein the decoder network is implemented by at least one of a generator network included in a generative adversarial network, a decoder portion of a variational autoencoder, or an invertible decoder represented by one or more normalizing flows.

17. The non-transitory computer readable medium of any of clauses 14-16, wherein the reweighting factor is applied to the one or more first values by resampling the one or more first values based on importance weights that are proportional to the reweighting factor.

18. The non-transitory computer readable medium of any of clauses 14-17 wherein the reweighting factor is applied to the one or more first values by iteratively updating the one or more first values based on a gradient of an energy function associated with the distribution and the reweighting factor.

19. The non-transitory computer readable medium of any of clauses 14-18, wherein the energy function comprises a difference between the prior distribution and the reweighting factor.

20. The non-transitory computer readable medium of any of clauses 14-19, wherein at least one of the one or more classifiers comprises a sequence of residual blocks, and at least one residual block in the sequence of residual blocks comprises a first batch normalization layer with a first Swish activation function, a first convolutional layer following the first batch normalization layer with the first Swish activation function, a second batch normalization layer with a second Swish activation function, a second convolutional layer following the second batch normalization layer with the second Swish activation function, and a squeeze and excitation layer.

21. The non-transitory computer readable medium of any of clauses 14-20, wherein the instructions further cause the processor to perform the step of generating the reweighting factor by computing a quotient of a probability that is output by the one or more classifiers and a difference between the probability and one.

22. The non-transitory computer readable medium of any of clauses 14-21, wherein the second component is implemented by at least one of a prior network or a Gaussian distribution.

23. The non-transitory computer readable medium of any of clauses 14-22, wherein the first component is implemented by at least one of an encoder portion of a variational autoencoder, a numerical inversion applied to a generator network included in a generative adversarial network, or an inverse of a decoder included in a normalizing flow network.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for creating a generative model, the method comprising:
performing one or more operations based on a plurality of training images to generate a trained encoder network and a trained prior network, wherein the trained encoder network converts each image included in the plurality of training images into a set of visual attributes, and the trained prior network learns a distribution of the set of visual attributes across the plurality of training images;
performing one or more operations to train one or more classifiers to distinguish between values for the set of visual attributes generated by the trained encoder network and values for the set of visual attributes selected from the distribution learned by the trained prior network; and
combining the trained prior network and the one or more classifiers to produce a trained prior component that is included in the generative model,
wherein, in operation, the trained prior component produces one or more values for the set of visual attributes in order to generate a new image that is not included in the plurality of training images.

2. The computer-implemented method of claim 1, wherein combining the trained prior network and the one or more classifiers comprises combining one or more first values selected from the distribution learned by the trained prior network with a reweighting factor that is based on the one or more first values.

3. The computer-implemented method of claim 1, wherein the new image comprises at least one face.

4. A computer-implemented method for creating a generative model, the method comprising:
performing one or more operations based on a training dataset to generate a trained encoder network and a trained prior network, wherein the trained encoder network converts a plurality of data points included in the training dataset into a set of latent variables, and the trained prior network learns a distribution of the set of latent variables across the training dataset;
performing one or more operations to train one or more classifiers to distinguish between values for the set of latent variables generated via the trained encoder network and values sampled from the distribution learned by the trained prior network; and
creating a trained prior component based on the trained prior network and one or more classifiers, wherein the trained prior component applies a reweighting factor to one or more first values sampled from the distribution learned by the trained prior network to generate one or more second values for the set of latent variables,
wherein, in operation, the trained prior component produces the one or more second values in order to generate a new data point that is not included in the training dataset.

5. The computer-implemented method of claim 4, wherein the distribution learned by the trained prior network comprises a hierarchy of latent variables, and wherein the one or more first values are sampled from the distribution learned by the trained prior network by:
sampling one first value from a first group of latent variables included in the hierarchy of latent variables; and
sampling another first value from a second group of latent variables included in the hierarchy of latent variables based on the first value and a feature map.

6. The computer-implemented method of claim 5, wherein the one or more classifiers comprise a first classifier that distinguishes between a third value sampled from the first group of latent variables using the trained prior network and a fourth value for the first group of latent variables generated by the trained encoder network, and a second classifier that distinguishes between a fifth value sampled from the second group of latent variables using the trained prior network and a sixth value for the second group of latent variables generated by the trained encoder network.

7. The computer-implemented method of claim 4, wherein the reweighting factor is applied to the one or more first values by resampling the one or more first values based on importance weights that are proportional to the reweighting factor.

8. The computer-implemented method of claim 4, wherein the reweighting factor is applied to the one or more first values by iteratively updating the one or more first values based on a gradient of an energy function associated with the distribution learned by the trained prior network and the reweighting factor.

9. The computer-implemented method of claim 4, wherein at least one of the one or more classifiers comprises a residual neural network.

10. The computer-implemented method of claim 9, wherein the residual neural network includes a first batch normalization layer having a first Swish activation function, a first convolutional layer, a second batch normalization layer having a second Swish activation function, a second convolutional layer, and a squeeze and excitation layer.

11. The computer-implemented method of claim 9, wherein the residual neural network includes a Swish activation function and a sequence of convolutional kernels.

12. The computer-implemented method of claim 4, further comprising calculating the reweighting factor based on output generated by the one or more classifiers from the one or more first values.

13. The computer-implemented method of claim 4, wherein performing the one or more operations to train the one or more classifiers comprises iteratively updating weights of the one or more classifiers based on a binary cross-entropy loss.

14. A non-transitory computer readable medium storing instructions that, when executed by a processor, cause the processor to perform the steps of:
performing one or more operations based on a training dataset to train a generative model, wherein the generative model includes a first component that converts a plurality of data points included in the training dataset into a set of latent variables and a second component that generates a prior distribution of the set of latent variables across the training dataset;
performing one or more operations to train one or more classifiers to distinguish between values for the set of latent variables generated via the first component and values sampled from the prior distribution; and
creating a trained prior component based on the second component and one or more classifiers, wherein the trained prior component applies a reweighting factor to one or more first values sampled from the prior distribution to generate one or more second values for the set of latent variables, wherein the reweighting factor is determined based on output generated by the one or more classifiers from the one or more first values,
wherein, in operation, the trained prior component produces the one or more second values in order to generate a new data point that is not included in the training dataset.

15. The non-transitory computer readable medium of claim 14, wherein the instructions further cause the processor to perform the steps of performing one or more decoding operations on the one or more second values via a decoder network included in the generative model to generate the new data point.

16. The non-transitory computer readable medium of claim 15, wherein the decoder network is implemented by at least one of a generator network included in a generative adversarial network, a decoder portion of a variational autoencoder, or an invertible decoder represented by one or more normalizing flows.

17. The non-transitory computer readable medium of claim 14, wherein the reweighting factor is applied to the one or more first values by resampling the one or more first values based on importance weights that are proportional to the reweighting factor.

18. The non-transitory computer readable medium of claim 14 wherein the reweighting factor is applied to the one or more first values by iteratively updating the one or more first values based on a gradient of an energy function associated with the distribution and the reweighting factor.

19. The non-transitory computer readable medium of claim 18, wherein the energy function comprises a difference between the prior distribution and the reweighting factor.

20. The non-transitory computer readable medium of claim 14, wherein at least one of the one or more classifiers comprises a sequence of residual blocks, and at least one residual block in the sequence of residual blocks comprises a first batch normalization layer with a first Swish activation function, a first convolutional layer following the first batch normalization layer with the first Swish activation function, a second batch normalization layer with a second Swish activation function, a second convolutional layer following the second batch normalization layer with the second Swish activation function, and a squeeze and excitation layer.

21. The non-transitory computer readable medium of claim 14, wherein the instructions further cause the processor to perform the step of generating the reweighting factor by computing a quotient of a probability that is output by the one or more classifiers and a difference between the probability and one.

22. The non-transitory computer readable medium of claim 14, wherein the second component is implemented by at least one of a prior network or a Gaussian distribution.

23. The non-transitory computer readable medium of claim 14, wherein the first component is implemented by at least one of an encoder portion of a variational autoencoder, a numerical inversion applied to a generator network included in a generative adversarial network, or an inverse of a decoder included in a normalizing flow network.
